(19) United States
(12) Patent Application Publication
(10) Pub. No.: US 2017/0336634 A1
(43) Pub. Date: Nov. 23, 2017

(54) AUGMENTED REALITY EYEWEAR AND METHODS FOR USING SAME

(71) Applicant: LAFORGE Optical Inc., San Mateo, CA (US)

(72) Inventors: Corey Mack, San Mateo, CA (US); Ron Blum, San Mateo, CA (US)

(21) Appl. No.: 15/399,800

(22) Filed: Jan. 6, 2017

Related U.S. Application Data
(63) Continuation of application No. 14/610,930, filed on Jan. 30, 2015, now abandoned.
(60) Provisional application No. 61/934,179, filed on Jan. 31, 2014.
(60) Provisional application No. 61/974,523, filed on Apr. 3, 2014.
(60) Provisional application No. 61/981,776, filed on Apr. 19, 2014.

(51) Int. Cl. G02B 27/01; G06F 3/01

(52) U.S. Cl. CPC G02B 27/0172; G06F 3/011; G02B 27/017; G02B 27/0176; G02B 2027/0178

(57) ABSTRACT

A system for displaying a virtual image in a field of vision of a user comprising a lens; a source for emitting a light beam; and a reflector configured to manipulate and direct the light beam to display the image as a virtual image. A method comprising placing a lens having a reflector in front of a user's eye; and projecting, onto the reflector, a light beam associated with an image; manipulating the light beam such that it is focused at a location beyond the reflector and directing it towards the user's eye to display the image as a virtual image. A system comprising first and second lenses, reflectors, and light sources; corresponding pathways along which the light beams are directed from the corresponding source, into the corresponding lens, along a body portion of the corresponding lens, and to the corresponding reflector for display as a virtual image.

### RELATED U.S. APPLICATIONS

This application is a continuation application of U.S. patent application Ser. No. 14/610,930, filed Jan. 30, 2015, which claims priority to U.S. Provisional Patent Application Ser. No. 61/934,179, filed Jan. 31, 2014, U.S. Provisional Patent Application Ser. No. 61/974,523, filed Apr. 3, 2014, and U.S. Provisional Patent Application Ser. No. 61/981,776 filed Apr. 19, 2014, each of which is hereby incorporated herein by reference in its entirety.

### TECHNICAL FIELD

The present invention relates to augmented reality systems, and more particularly, the display of virtual images in a user's field of vision.

### BACKGROUND

Existing augmented reality eyewear suffers from a number of disadvantages. In one aspect, many systems project an image with a focal point very close to the user's eye, causing a user to have to repeatedly shift its focus from close to far to view the image and the surrounding environments, respectively. This can be uncomfortable and distracting to the user. In another aspect, many systems suffer from unpleasant aesthetics, such as thick lenses or protruding hardware. In particular, in an effort to minimize the profile of eyewear frames, some systems provide all or a majority of their image generating hardware within the eyewear lenses. This may make the lenses very thick and heavy. Thicknesses of 5 mm, or even 7 mm-10 mm are not uncommon. Other systems, such as Google Glass, take an opposite approach, housing all or a majority of image generating hardware in the eyewear frame. While this may provide for thinner lenses, the frame may be visually conspicuous. This may make the user feel self-conscious and resistant to wearing the eyewear in public.

In light of these issues, it would be desirable to provide an augmented reality system having an aesthetically pleasing profile approaching that of traditional ophthalmic eyewear, and configured to overlay images at focal points associated with a user's normal field of vision.

### SUMMARY OF THE INVENTION

The present disclosure is directed to a system for displaying a virtual image in a field of vision of a user. The system may comprise a lens for placement in front of an eye of a user, having a reflector positioned at least partially there within. The reflector may be configured to manipulate a light beam emitted from a source such that an image associated with the light beam is focused at a location beyond the reflector. The reflector may be further configured to direct the manipulated light beam towards the user's eye to display the image as a virtual image in the field of vision of the user.

In an embodiment, the light beam may be directed along a pathway extending from the source, into the lens, along a body portion of the lens to the reflector, and towards the eye of the user. The light source may be placed in a front portion of the frame to avoid misalignment of the pathway that may result from torque or bending of anterior portions of the frame.

In various embodiments, the reflector may include one of a reflective surface, a prism, a beam splitter, an array of small reflective surfaces similar to that of a digital micrometer, and a reflective surface of a recess within the lens, amongst other possible structure.

In various embodiments, the reflector may be positioned in one of a central portion, a near-peripheral portion, or a peripheral portion of the user's field of vision. The associated virtual image may be displayed in a corresponding portion of the user's field of vision.

In various embodiments, the system may be provided such that the lens has a nominal thickness, and the frame (if provided) is of narrow dimensions, thereby maintaining the aesthetic appeal of conventional ophthalmic eyewear.

In various embodiments, the system may further include electronic components for providing power, processing data, receiving user inputs, sensing data from the surrounding environment, amongst other suitable uses.

In another aspect, another system is provided comprising first and second lenses, each having a reflector positioned at least partially there within. Corresponding light beams from first and second sources may be directed along corresponding pathways to the reflectors. Each pathway may extend from the corresponding source, into the corresponding lens, along a body portion of the corresponding lens, and to the corresponding reflector. The reflectors may be configured to manipulate the corresponding light beams to be focused at locations beyond the reflectors, and to direct, from within the corresponding lens and towards the corresponding eye of the user, the corresponding manipulated light beams to display the images associated with the light beams as virtual images separately in the field of vision of the user.

In yet another aspect, the present disclosure is directed to a method for displaying a virtual image in a field of vision of a user. The method may include the steps of providing a lens having a reflector embedded at least partially therein; placing the lens in front of an eye of the user; projecting, onto the reflector, a light beam associated with an image; manipulating, via the reflector, the light beam such that it is focused at a location beyond the reflector; and directing, via the reflector, the manipulated light beam towards the eye of the user to display the image as a virtual image in the field of vision of the user.

In still another aspect, the present disclosure is directed to method for adjusting the display of content in a field of vision of the user based on movement of the user. The method may comprise the steps of measuring at least one of a position, a velocity, or an acceleration of the user; associating the measured position, velocity, acceleration of the user, or combination thereof, with the content to be displayed to the user; and adjusting one of or a combination of the following for display to the user, based on the associated position, velocity, and/or acceleration of the user: an amount of the content to be displayed; a rate at which the content is to be displayed, and a size of the content to be displayed.

### BRIEF DESCRIPTION OF DRAWINGS

For a more complete understanding of this disclosure, reference is now made to the following description, taken in conjunction with the accompanying drawings, in which:

FIG. 1 illustrates a perspective view of an augmented reality system, in accordance with one embodiment of the present disclosure;

FIG. 2A illustrates a perspective view of a lens of an augmented reality system, in accordance with one embodiment of the present disclosure;

FIG. 2B illustrates a perspective view of another lens of a augmented reality system, in accordance with another embodiment of the present disclosure;

FIG. 3A depicts a perspective schematic view of a virtual image pane of an augmented reality system, in accordance with one embodiment of the present disclosure;

FIG. 3B depicts a top schematic view of a virtual image pane of an augmented reality system, in accordance with another embodiment of the present disclosure;

FIG. 3C depicts top and front schematic views of lenses having reflectors of varying dimensions as placed near a path of a light beam, in accordance with another embodiment of the present disclosure;

FIG. 3D depicts a graph showing the effect of varying field position on illumination for a fixed display size;

FIG. 3E depicts graphical representations of the effect of varying field position on image magnification and vignetting;

FIG. 4A illustrates a perspective view of a frame of an augmented reality system, in accordance with one embodiment of the present disclosure;

FIG. 4B illustrates a top cross-sectional schematic view of an augmented reality system having a front facing light source, in accordance with one embodiment of the present disclosure;

FIG. 4C illustrates a top cross-sectional schematic view of an augmented reality system having a side facing light source, in accordance with one embodiment of the present disclosure;

FIG. 5A illustrates possible locations of various electronic components in a frame of an augmented reality system, in accordance with one embodiment of the present disclosure;

FIG. 5B illustrates possible locations of various electronic components in a frame of an augmented reality system, in accordance with another embodiment of the present disclosure;

FIG. 5C illustrates an hidden image sensor and associated collector of an augmented reality system, in accordance with another embodiment of the present disclosure;

FIG. 6A depicts a perspective schematic view of a lens/virtual image pane assembly of an augmented reality system, in accordance with one embodiment of the present disclosure;

FIG. 6B depicts front and side views of a mold for making lens/reflector of an augmented reality system, in accordance with one embodiment of the present disclosure;

FIG. 6C depicts a side schematic view of a lens/reflector assembly, in accordance with yet another embodiment of the present disclosure;

FIG. 6D depicts top schematic views of lens/virtual image pane assemblies of varying thicknesses, in accordance with still another embodiment of the present disclosure;

FIG. 7A depicts a schematic view of a user's field of vision for reference in describing possible placements of a reflector(s) and associated virtual image(s) therein.

FIGS. 7B-7H schematically depict, from left to right, (a) various placements of a reflective surface in a lens of an augmented reality system and the approximate resulting eye position in order to view the image in that location, (b) an associated placement of the reflective surface in a user's field of vision, and (c) an associated merged field of view provided thereby.

FIG. 8A depicts a schematic view of a merged field of vision displaying widgets and operating information, in accordance with an embodiment of the present disclosure; and

FIG. 8B depicts a schematic view of a merged field of vision displaying navigational information, widgets, and operating information, in accordance with another embodiment of the present disclosure.

### DESCRIPTION OF SPECIFIC EMBODIMENTS

Embodiments of the present disclosure generally provide systems and methods for creating an augmented reality experience through the display of a virtual image in a field of vision of a user.

### Augmented Reality System 100

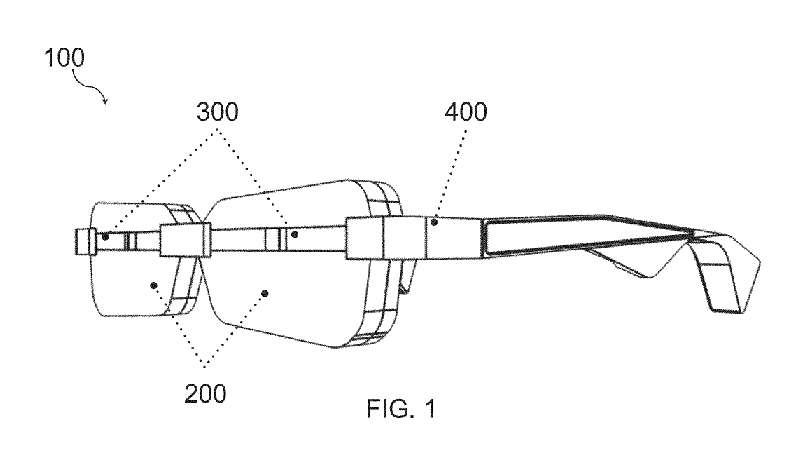

FIGS. 1-6D illustrate representative configurations of an augmented reality system 100 and components thereof. It should be understood that the components of augmented reality system 100 shown in FIGS. 1-6D are for illustrative purposes only, and that any other suitable components or subcomponents may be used in conjunction with or in lieu of the components comprising augmented reality system 100 described herein.

Embodiments of augmented reality system 100 may be used standalone, or as a companion device to a mobile phone (or other suitable electronic device) for processing information from the mobile phone, a user, and the surrounding environment, and displaying it in a virtual image to a user, amongst other possible uses.

FIG. 1 depicts an embodiment of augmented reality system 100. System 100 may generally include one or more ophthalmic lenses 200, one or more virtual image panes 300, a frame 400, and various electronic components 500 (not shown), all of which are described in more detail herein.

### Ophthalmic Lens 200

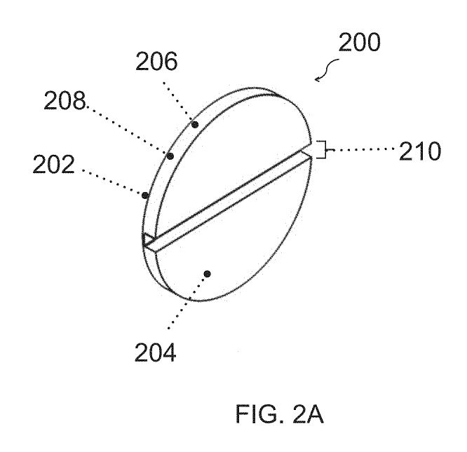

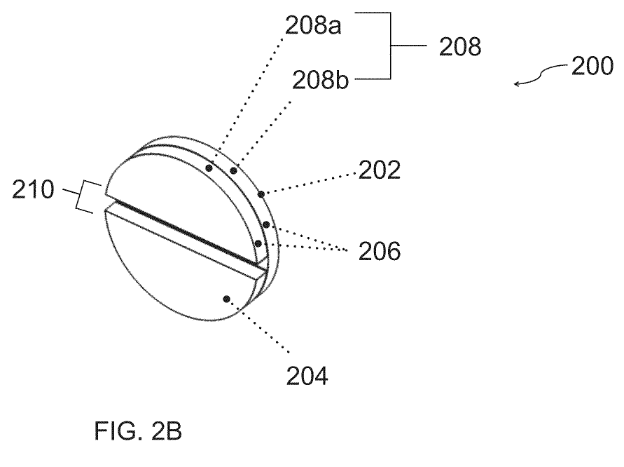

Referring now to FIGS. 2A and 2B, system 100 may include one or more ophthalmic lenses 200 to be positioned in front of one or both of the user's eyes. In an embodiment, system 100 may include a single ophthalmic lens 200 suitable for positioning in front of a single eye, much like a monocle. In another embodiment, system 100 may include a single ophthalmic lens 200 suitable for positioning in front of both eyes, much like a visor of the type worn on a football or fighter pilot helmet. In yet another embodiment, system 100 may include two ophthalmic lenses 200 suitable for positioning in front of both eyes, respectively, in a manner similar to spectacle lenses. In various embodiments, ophthalmic lens 200 may be shaped to provide an optical power for vision correction; in others, no such optical power shaping is included.

Ophthalmic lens 200 may be made of any suitable transparent or translucent material such as, without limitation, glass or polymer. Lens 200, in an embodiment, may include a protective coating to prevent scratches or abrasions. Lens 200 may also be manufactured so as to be colored, tinted, reflective, reduced glare, or polarized, for increased comfort in bright environments. Lens 200 may also be a transition lens, configured to transition between various states of transparency depending on the brightness of the surrounding environment.

As shown in FIGS. 2A and 2B, a typical lens 200 may include a front surface 202, a back surface 204, an edge 206, and a body 208 defining a thickness of lens 200. In an embodiment, lens 200 may be of a one-piece construction, as shown in FIG. 2A. In another embodiment, lens 200 may be of a multi-piece construction, as depicted by the adjoining body pieces 208a,b in FIG. 2B.

Lens 200 may be of suitable thickness to accommodate one or more components of virtual image pane 300 there within. In some embodiments, lens 200 may be provided with a recess 210 having suitable dimensions for receiving said components. Recess 210, in one such embodiment, may have a channel-like shape extending along the length of lens 200 and into body 208 through either of lens surfaces 202, 204, as shown. In other embodiments, recess 210 may not be provided, as components of virtual image pane 300 may be integrated into lens 200 during manufacture, as later described.

### Virtual Image Pane 300

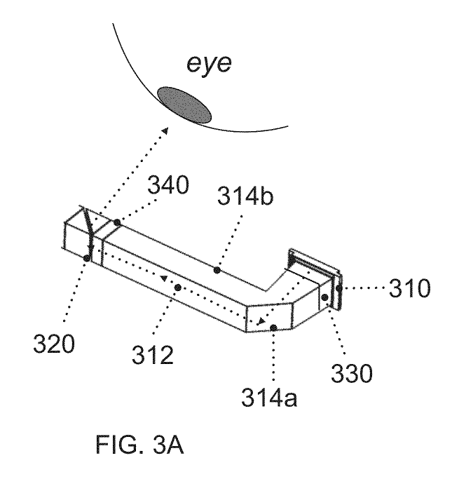

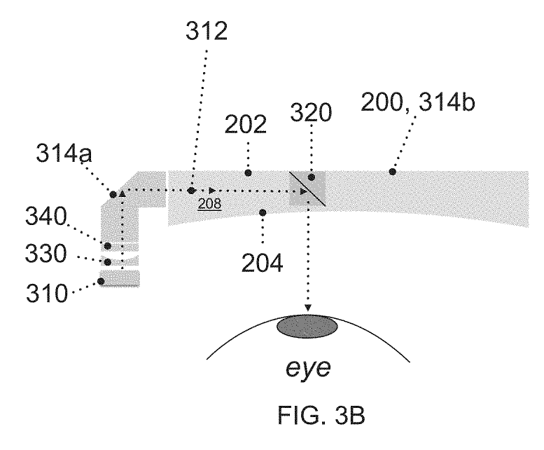

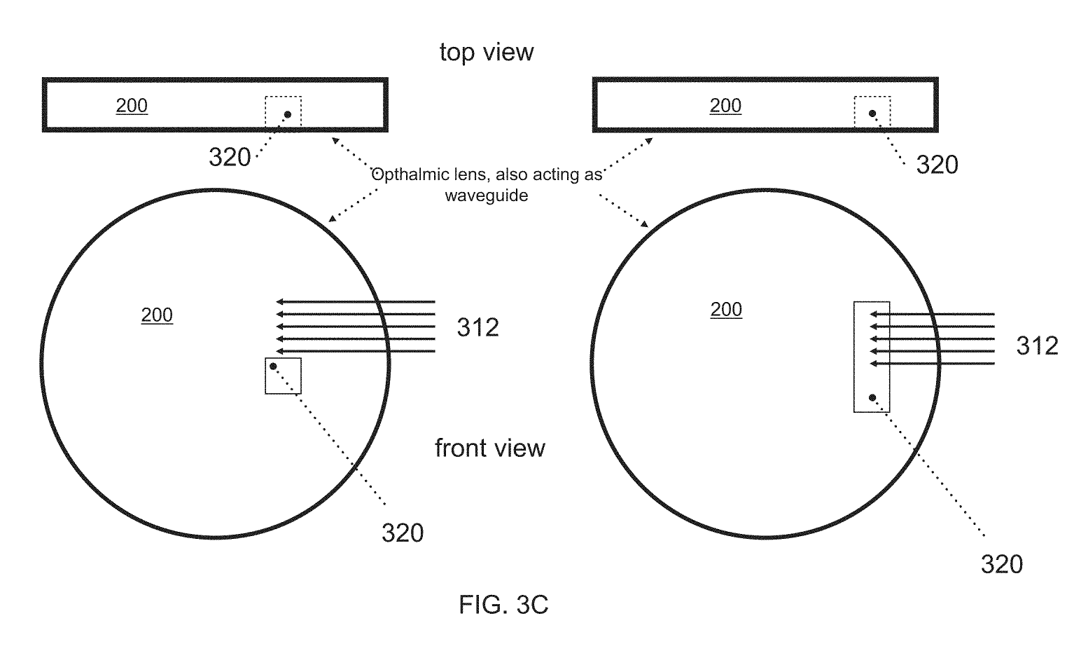

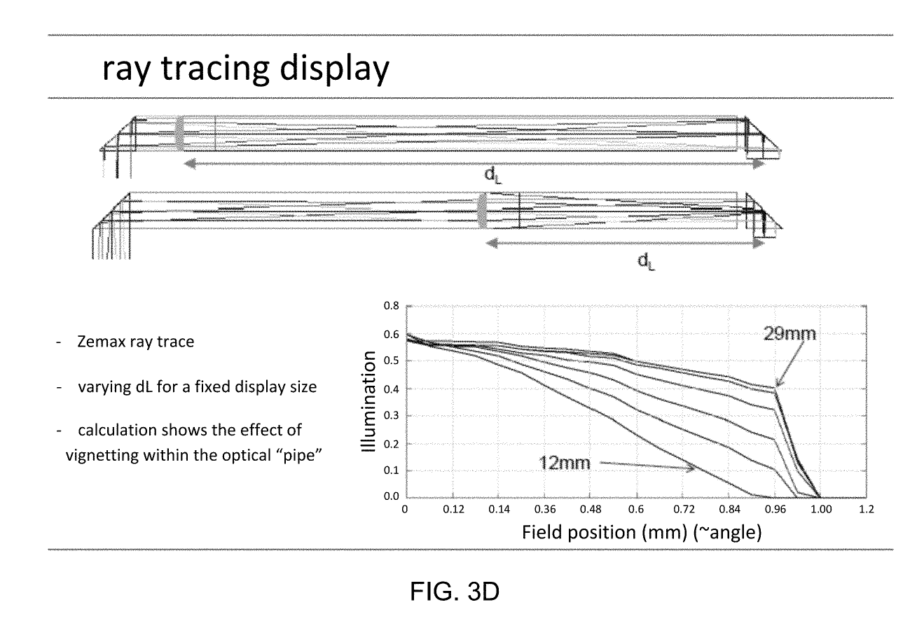

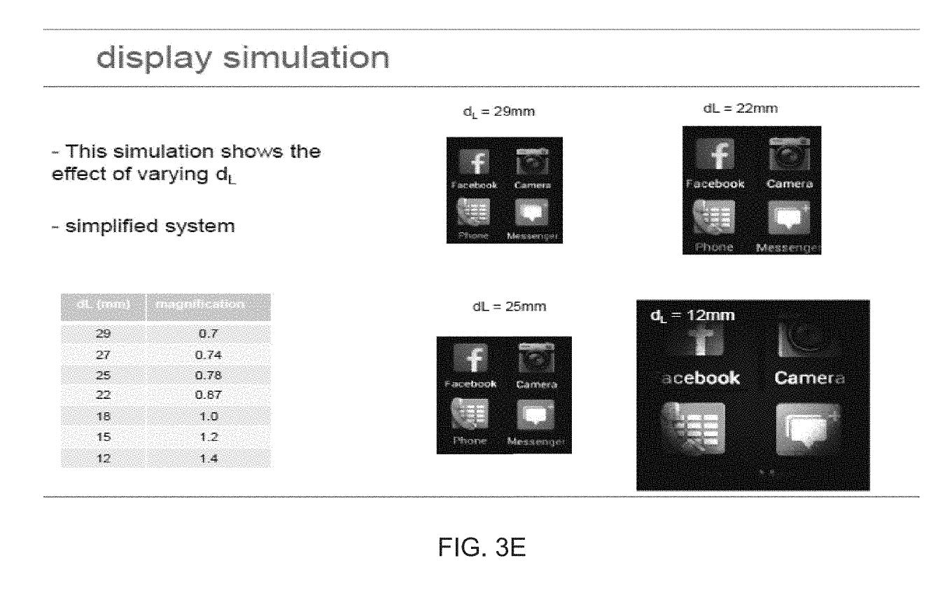

Referring now to FIGS. 3A and 3B, system 100 may further include one or more virtual image panes 300 for creating a corresponding number of virtual image(s) in a user's field of vision. A virtual image is formed when incoming light rays are focused at a location beyond the source of the light rays. This creates the appearance that the object is at a distant location, much like a person's image appears to be situated behind a mirror. In some cases, the light rays are focused at or near infinity. Virtual image pane 300 may generally include a light source 310 and a reflector 320. In some embodiments, virtual image pane 300 may further include a focusing lens 330 and a collimator 340, as described in more detail herein.

Referring first to FIGS. 3A and 3B, virtual image pane 300 may include a light source 310 for emitting a light beam associated with an image. Accordingly, light source 310 may be placed in optical communication with these other components.

Light source 310 may include any suitable device for emitting a light beam associated with an image to be displayed. In various embodiments, light source 310 may include, without limitation, an electronic visual display such as an LCD or LED backlit display, laser diode, liquid crystal on silicon (LCOS) display, cathodoluminescent display, electroluminescent display, photoluminescent display, and incandescent display. In an embodiment, light emitted from light source 310 may be split into different wavelengths and combined later in virtual image pane 300.

The emitted light beam may be directed through other components of virtual image pane 300 along a pathway 312 for subsequent display to a user as a virtual image. Generally speaking, pathway 312 extends from light source 310, through a portion of lens 200, and toward an eye of the user.

One or more wave guides 314 may be provided for directing the light beam along portions of path 312. Wave guide(s) 314 may be of any shape, size, and dimensions, and construction suitable for this purpose. In an embodiment, wave guide 314 may include one or more reflective surfaces to direct the light along respective portions of pathway 312. In another embodiment, wave guide 314 may include an optical guide element, such as an optical pipe or fiber optic cable. In yet another embodiment, a portion of lens 200 itself may serve as wave guide 314—that is, lens body 208 may provide a transmission medium for the light beam and serve to direct it along pathway 312.

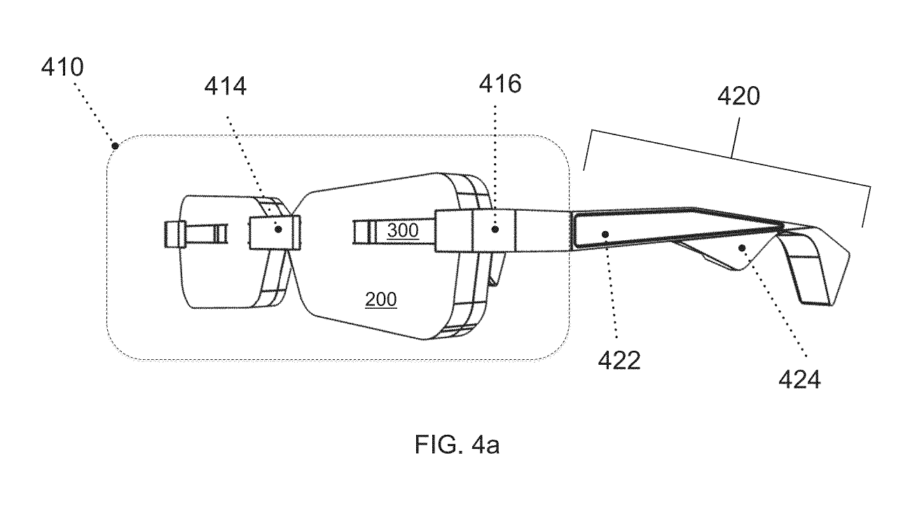

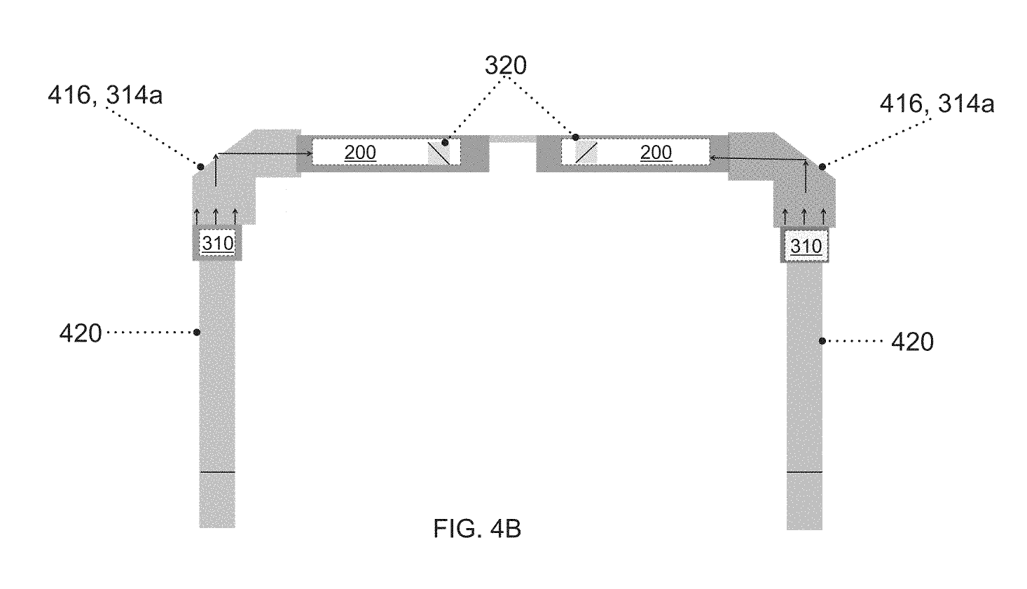

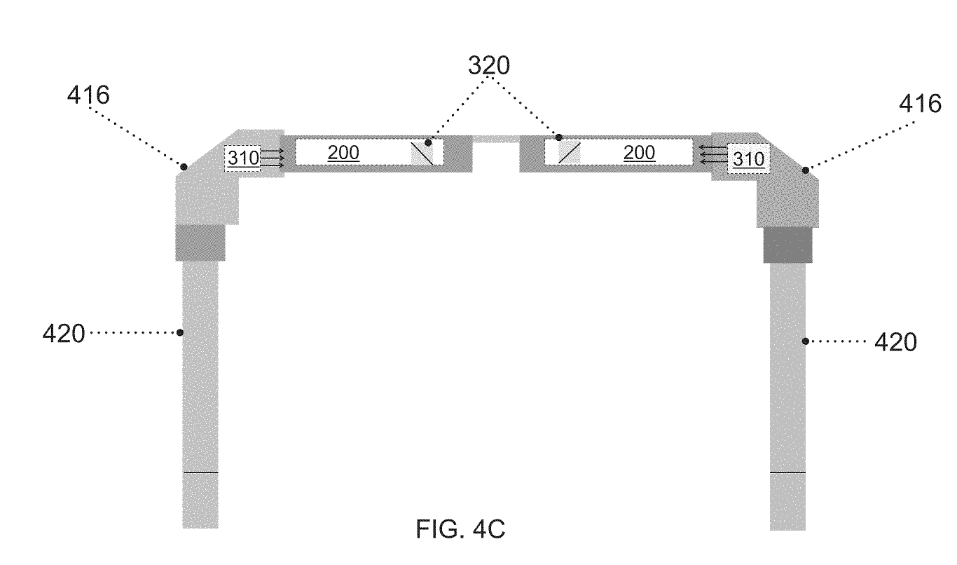

In an embodiment, as shown in FIG. 3A, wave guide 314 may be provided along the majority of pathway 312; that is, between light source 310 and reflector 320. A first portion 314a may be provided direct the light beam along pathway 312 from light source 310 to lens 200, if necessary. This may be the case when light source 310 is not aligned with that portion of path 312 extending through lens 200, as shown in FIG. 3A. Conversely, should light source 310 be positioned proximate to and aligned with lens 200, as later shown in FIG. 4C, wave guide 314a may not be necessary and may not be present.

A second wave guide portion 314b may also be provided direct the light beam along pathway 312 through a portion of lens 200 extending between wave guide 314a and reflector 320. In one such embodiment, wave guide 314b may include a substantially hollow channel within lens 200. This channel may have any suitable shape such as a triangle, ellipse, quadrilateral, hexagon, or any other suitable closed multi-sided or cylindrical shape. The channel may further have a shape similar to a homogenizing light pipe or a tapering/multi-tapering homogenizing rod. The channel may be of constant cross-section, or it may taper along all or various portions of its length. One or more ends of wave guide 314b may be flat, angled, or curved. This may serve to redirect, change the focal point, and/or concentrate the light beam. The channel interior may also be filled with air, a gas, a liquid, or may form a vacuum. In some embodiments, wave guide 314 may be configured to manipulate the light in manners similar to the way a GRIN lens, cone mirror, wedge prism, rhomboid prism, compound parabolic concentrator, or rod lens would.

Referring now to FIG. 3B, as previously noted, lens 200 may act as wave guide 214b—that is, the light beam may be directed through a portion of body 208 towards reflector 320. In one such embodiment, the light beam may enter lens 200 through edge 206 and travel through body 208 between front and back surfaces 202, 204 towards reflector 320. Where body 208 serves to direct the light beam through lens 200, wave guide 214b is merely conceptual and is not defined by any separately distinguishable structure from lens 200.

In some embodiments, wave guide 314 or portions thereof may be made of a substantially transparent, semi-transparent or translucent material, such as glass, polymer, or composite. In certain embodiments, this may provide for wave guide 314 to be less visible (or virtually invisible) when coupled or otherwise integrated with lens 200, thereby minimizing user discomfort and improving aesthetics of system 100. Transparent, semi-transparent, or translucent embodiments may further provide for light from the surrounding environment to enter wave guide 314. In an embodiment, wave guide 314 may be made of or coated with a material suitable for blocking out certain wavelengths of light from the surrounding environment, while still allowing other wavelengths of light to enter and/or pass completely through the cross-section wave guide 314.

Referring back to both FIGS. 3A and 3B, virtual image pane 300 may further comprise one or more reflectors 320 for manipulating the light beam as further described herein. Reflector 320 may further serve to direct, from within lens 200 and towards an eye of the user, the manipulated light beam to display the image from light source 310 as a virtual image in the user's field of vision.

In order to create a virtual image from the image transmitted by the light beam, reflector 320 may be configured to manipulate the light in a manner that causes the rays of the light beam to diverge in a manner that makes the corresponding image appear focused at a location beyond reflector 320. This may have the effect of making the image appear to be situated out in front of the user, thereby allowing the user to clearly focus on both the image and distal portions of the environment at the same time.

In various embodiments, reflection or refraction may be used to manipulate the light beam in such a manner. As such, reflector 320 may include any suitable reflective surface, combination of reflective surface, or refractive object capable of reflecting or refracting, respectively, the light beam to form a virtual image.

As illustrated in FIG. 3A, in one embodiment, reflector 320 may include a prism, such as a triangular prism. Of course, other types of prisms such as dove prisms, penta prisms, half-pint prisms, Amici roof prisms, Schmidt prisms, or any combination thereof, may also be used additionally or alternatively. In another embodiment, multiple reflective surfaces may be arranged relative to one another to direct the light in similar ways to such prisms

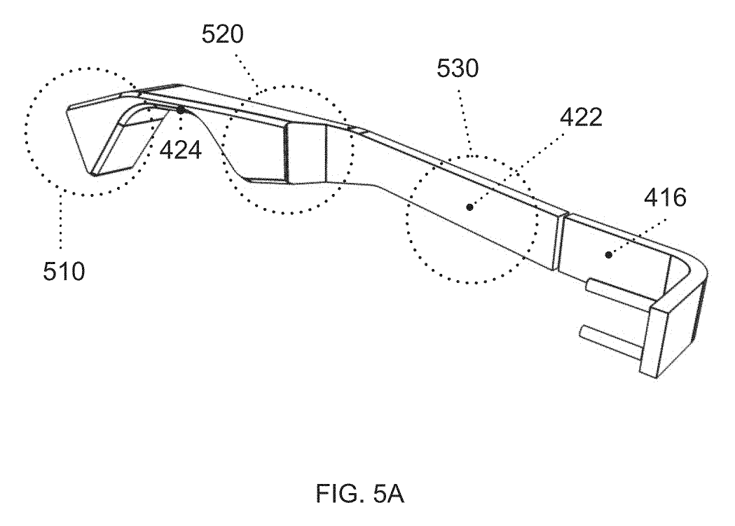

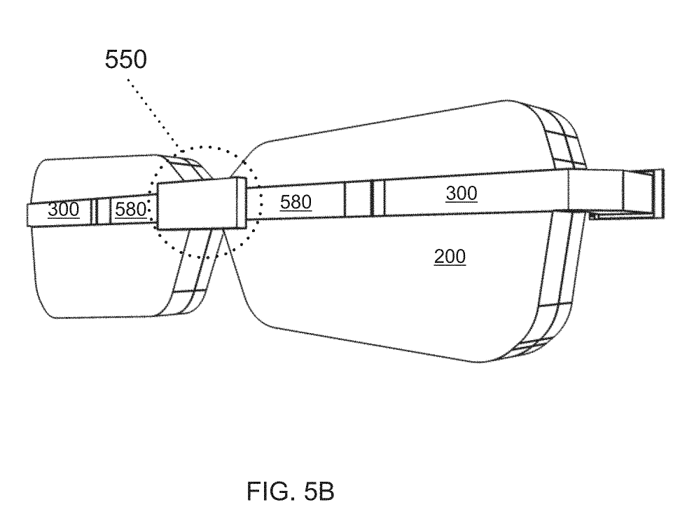

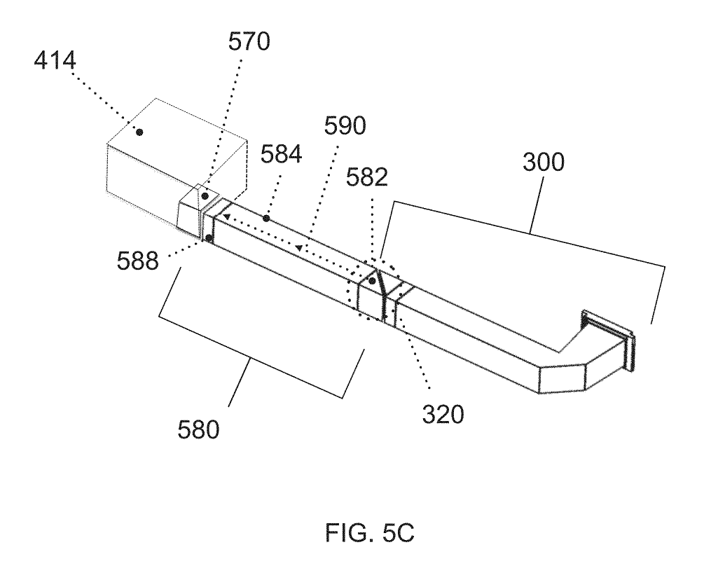

As shown in FIG. 3B, in another embodiment, reflector 320 may include a beam splitter. A beam splitter is an optical device formed of two triangular prisms joined together at their bases to make a cube or rectangular structure. Incoming light may be refracted by a respective prism, and a resin layer at the juncture between the prisms may serve to reflect a portion of any light penetrating thereto. Together, depending on the orientation, one of these triangular prisms and the effective reflective surface provided by the juncture, may serve to manipulate the light as described above, and direct the manipulated light towards an eye of the user. The other triangular prism may serve to direct light from the surrounding environment into a collector 580, where it may then be directed elsewhere in system 100, such as to an image sensor 550 for image capture, as later described in the context of FIG. 5C. It should be understood; however, that a beam splitter (or a modified embodiment thereof comprising a triangular prism having a reflective surface thereon) may still be utilized as reflector 320, independent of the presence of collector 580.

In yet an embodiment, reflector 320 may take the form of a reflective surface, such as a mirror, suspended within lens 200. In still another embodiment, reflector 320 may take the form of a reflective inner surface of wave guide 314, if equipped. For example, one or more of the reflective surfaces within a holographic or diffractive wave guide 314 may be suitable for this purpose. Still further, in an embodiment, reflector 320 may take the form of a reflective inner surface surrounding a recess within lens 200. Moreover, in another embodiment, reflector 320 may include a collection of smaller reflective surfaces arranged to create an array similar to that of a digital micromirror device as used in DLP technology. Such a digital micromirror device may allow for electronically-controlled beam steering of the light into the user's field of vision. Of course, these are merely illustrative embodiments of reflector 320, and one of ordinary skill in the art will recognize any number of suitable reflective surfaces, refractive objects, and configurations thereof suitable for manipulating the light beam as described, and directing it, from within lens 200 and towards a user's eye, to display the image from light source 310 as a virtual image in the user's field of vision.

Referring now to FIG. 3C, it should be noted that, in some cases, an elongated embodiment of reflector 320 (e.g., a rectangular prism) may be preferable over a shorter embodiment (e.g., a cube-shaped prism), as an elongated embodiment may be more forgiving in terms of alignment issues. That is, should pathway 312 be altered in some way that takes the light beam out of an intended alignment with reflector 320—as may be the case if frame 400 (later described) were to warp or if the manufacture of various components of system 100 were to fall out of tolerance—an elongated embodiment (shown here with a vertical orientation within lens 200) may be better suited to capture light travelling along the resultant errant pathway 312 that may otherwise miss a shorter reflector 320. While described here in the context of a beam splitter, it should be recognized that other embodiments of reflector 320 may be similarly elongated to account for misalignments in pathway 312.

Referring back to FIGS. 3A and 3B, virtual image pane 300 may further comprise one or more focusing lenses 330 disposed along pathway 312. Focusing lens 330 may serve to compensate for the short distance between the light source 310 and the user's eye by focusing the light beam such that the associated image may be readily and comfortably seen by the user. Focusing lens 330 may include any lens known in the art that is suitable for focusing the light beam (and thus, the corresponding image) emitted by light source 310, and may have a positive or negative power to magnify or reduce the size of the image.

In an embodiment, focusing lens 330 may be tunable to account for variances in pupil distance that may cause the image to appear out of focus. Any tunable lens known in the art is suitable including, without limitation, an electroactive tunable lens similar to that described in U.S. Pat. No. 7,393,101 B2 or a fluid filled tunable lens similar to those described in U.S. Pat. Nos. 8,441,737 B2 and 7,142,369 B2, all three of which being incorporated by reference herein. Tunable embodiments of focusing lens 330 may also be tunable by hand or mechanical system wherein the force applied changes the distance in the lenses.

Focusing lens 330 may be situated in any suitable locations along pathway 312. As shown in FIG. 3A, in an embodiment, focusing lens 330 may be placed near light source 310. Such an arrangement may have the benefits of focusing the image at the outset of its travel along pathway 312, allowing focusing lens 330 to be tunable, and removing focusing lens 330 from the field of view of the user. Of course, this is merely an illustrative embodiment, and one of ordinary skill in the art will recognize other suitable locations for focusing lens 330 of virtual image pane 300.

Still referring to FIGS. 3A and 3B, virtual image pane 300 may further comprise one or more collimators 340. In various embodiments, collimator(s) 340 may be situated along pathway 312 to help align the individual light rays of the light beam travelling there along. This can reduce image distortion from internal reflections. In doing so, collimator 340 may prepare the light beam in a manner that will allow the virtual image to appear focused at a far distance from the user or at infinity. Collimator 340 may also provide for the virtual image to be seen clearly from multiple vantage points.

In an embodiment, collimator 340 may include any suitable collimating lens known in the art, such as one made from glass, ceramic, polymer, or some other semi-transparent or translucent material. In another embodiment, collimator 340 may take the form of a gap between two other hard translucent materials that is filled with air, gas, or another fluid. In yet another embodiment, collimator 340 may include a cluster of fiber optic strands that have been organized in a manner such that the strands reveal an output image that is similar to the image from light source 310. That is, the arrangement of strand inputs should coincide with the arrangement of the strand outputs. In still another embodiment, collimator 340 may include a series of slits or holes in a material of virtual image pane 300, or a surface that has been masked or coated to create the effect of such small slits or holes. Depending on the given embodiment, a collimating lens may be less visible than the aforementioned fiber optic strand cluster, providing for greater eye comfort and better aesthetics, and may be a better option if the fiber optic strands are too small to allow certain wavelengths of light pass through. Of course, collimator 340 may include any device suitable to align the light rays such that the subsequently produced virtual image is focused at a substantial distance from the user.

Collimator 340 may be situated in any suitable location along pathway 312. As shown in FIG. 3A, in an embodiment, collimator 340 may be placed near reflector 320. Such an arrangement may provide for extra collimation for the increased view comfort and reduced eye strain of the user. As shown in FIG. 3B, in another embodiment, collimator 340 may be placed near light source 310. Of course, these placements are merely illustrative, and one of ordinary skill in the art will recognize other suitable locations for collimator 340 along pathway 312.

Referring now to FIGS. 3D and 3E, placement of focusing lens 330 and collimator 340 may affect the magnification and possible vignetting of the image. Specifically, variances in d_{L} for a fixed display size may affect the magnification of the image. In some cases, if magnification is too extreme, partial vignetting may occur, as shown in FIG. 3E.

### Frame 400

Referring now to FIGS. 4A-4C, system 100 may further include a frame 400. In an embodiment, frame 400 may house the various other components of system 100. In another embodiment, frame 400 may provide for system 100 to be worn in front of one or both of a user's eyes.

Referring to FIG. 4A, in an illustrative embodiment, frame 400 may take the form of a pair of spectacle frames. For example, frame 400 may generally include a frame front 410 and frame arms (also known as the temple) 420. Frame front 410 may include rims 412 (not shown in this particular rimless design) for receiving lenses 200, a bridge 414 connecting the rims 414/lenses 200, and end pieces 416 for connecting the rims 414/lenses 200 to frame arms 420. Frame arms 420 may each include an elongated supporting portion 422 and a securing portion 424, such as an earpiece. Frame arms 420 may, in some embodiments, be connected to end pieces 416 of the frame front 410 via hinges. Of course, frame 400 may take any other suitable form including, without limitation, a visor frame, a visor or drop down reticle equipped helmet, a pince-nez style bridge for supporting system 100 on the nose of the user, etc.

Referring to FIGS. 4B and 4C, frame 400 may house lens 200 and virtual image pane 300 in any suitable configuration. In one configuration, frame 400 may receive left and right lenses 200 in left and right rims 412, respectively, such that each virtual image pane 300 associated with each of lens 200 extends into its corresponding end piece 416. Each light source 310 may be situated within its respective end piece 416 in any suitable orientation. In an embodiment, as shown in FIG. 4B, one or both light sources 310 may be oriented substantially parallel to frame arms 420 so as to emit their respective images in a forward facing direction. Such an arrangement may require the emitted light beam to be directed laterally at some point (i.e., along the length of lens 200), as shown back in FIGS. 3A and 3B, in order to reach reflector 320 and, ultimately, the user's eye. In such a case, end piece 416 may contain, or be modified to serve as, wave guide 314a. In a preferred embodiment, an end piece or frame front would run around the waveguide 314a connecting lens 200 to temple 420 thus isolating wave guide 314a that has image source 310 attached to it, and the display from torque. Note that in this embodiment the waveguide 314a and the display need not be attached to the end piece 416 and are thus free floating relative to the end piece 416 and the temple 420. This same embodiment would not necessarily require attachment to said temple. In another embodiment, as shown in FIG. 4C, one or both light sources 310 may be oriented substantially laterally so as to emit their respective images more directly toward their respective reflective surfaces 350. This lateral embodiment may be preferable from at least a simplicity standpoint should sufficient packaging space be available in end pieces 416, and the desired aesthetics of frame 400 maintained. It should be recognized that configurations of frame 400 in which the entirety of virtual image pane 300, including light source 310, is housed in frame front 410 may be preferable, as frame arms 420 may flex, or rotate about the hinges, making it more difficult to properly transmit the light beam from a light source 310 located therein.

Referring now to FIGS. 5A-5C, system 100 may further include various electronic components 500. In various embodiments, electronic components may provide power, process data, receiver user inputs, sense data from the surrounding environment, or have any other suitable use.

For example, electronic components 500 may include one or more of the following, without limitation:
Power source 510 for providing electrical power to various components of system 100, such as light source 310 and other electronic components 500. Power source 510 may include any suitable device such as, without limitation, a battery, power outlet, inductive charge generator, kinetic charge generator, solar panel, etc.;
Microphone and or speaker 520 for receiving/providing audio from/to the user or surrounding environment;
Touch sensor 530 for receiving touch input from the user, such as a touchpad or buttons;
Microelectromechanical sensor (MEMS) 540, such as accelerometers and gyros, for receiving motion-based information. MEMS similar in function to Texas Instruments DLP chip may provide for system 100 to redirect the virtual image within the user's field of vision based on relative velocity, acceleration, orientation of system 100 (and by extension, the user's head); and
Transceiver 550 (not shown) for communicating with other electronic devices, such as a user's mobile phone. Transceiver 550 may operate via any suitable short-range communications protocol, such as Bluetooth, near-field-communications (NFC), and ZigBee, amongst others. Alternatively or additionally, transceiver 550 may provide for long-range communications via any suitable protocol, such as 2G/3G/4G cellular, satellite, and WiFi, amongst others. Either is envisioned for enabling system 100 to act as a standalone device, or as a companion device for the electronic device with which it may communicate.
Microprocessor 560 (not shown) for processing information. Microprocessor, in various embodiments, may process information from another electronic device (e.g., mobile phone) via transceiver 550, as well as information provided by various other electronic components 500 of system 100. In an embodiment, an FPGA or ASIC, or combination thereof, may be utilized for image processing, and processing of other information.
Image sensor 570 for receiving images and/or video from the surrounding environment.

Electronic components may be situated on or within housing 400 in any suitable arrangement. Some potential locations, as illustrated by the dotted regions illustrated in FIGS. 5A and 5B, include elongated supporting portion 422, securing portion 424, and bridge 414. For example, in the illustrated embodiment, power source 510 and microphone/speaker 520 may be situated in rear and front areas of securing portion 424, respectively, touchpad 530 may be situated in elongated supporting portion 520, and image sensor 570 may be situated in bridge 414. Electronic components 500 may be packaged in one or both of frame arms 420, as well as in end pieces 416, space permitting. Any number of configurations and combinations of electronic components 500 are envisioned within the scope of the present disclosure.

In various embodiments, an image sensor 570 may be provided in bridge 414. In one embodiment, image sensor 570 may be front-facing (not shown). It should be noted that in such a configuration, a lens of the front-facing image sensor 570 may be visible. In some cases, this may reduce the aesthetics of system 100—that is, a lens on a forward-facing camera may protrude from and appear to be of a different color than frame 400. Some may find this unsightly. Further, the visible appearance of a camera on one's glasses can attract unwanted attention, potentially causing other people to feel self-conscious, irritated, upset, or even violent, perhaps due to feelings that their privacy is being violated. Accordingly, in another embodiment as shown in FIGS. 5B and 5C, system 100 may be provided with a hidden image sensor 570 (i.e., one in which a lens thereof is not readily visible to others).

Referring to FIG. 5C, in such an embodiment, system 100 may be further provided with a collector 580 for gathering light from the surrounding environment via lens 200 and directing the gathered light to hidden image sensor 570. By routing light from the surrounding environment to image sensor 570 via collector 580—without the visible appearance of a camera lens—one can capture image data while potentially avoiding these issues. Such an arrangement may also avoid parallax; i.e., the displacement between the real image and the image produced by the system or a component of the system.

An exemplary embodiment of collector 580 is illustrated in FIG. 5C. Collector 580, much like virtual image pane 300, may include a reflector 582, a wave guide 584, a focusing lens 586, and a collimator 588. Any suitable number, combination, and arrangement of these components may be used. Light from the surrounding environment may be gathered through reflective surface 582 (and possibly through transparent walls of the other components) and directed along a path 590 and through collimator 586, ultimately entering image sensor 570. Image sensor 570, in the illustrated embodiment, is side-facing as indicated by the arrow thereon, to receive light from collector 580.

Like virtual image pane 300, collector 580 may be partially or fully situated within lens 200. It may be formed integrally with lens 200, or formed separately and coupled into recess 210. In an embodiment, collector 580 may extend from bridge 414 to virtual image pane 300, as shown. While separate reflectors 582, 350 may be used for collector 580 and virtual image pane 300, respectively, in such an embodiment, a shared reflector may be used if desired. For example, a beam splitter, formed of two triangular prisms as shown, may be utilized. In the proper configuration, light entering the collector 580 side of the beam splitter from the surrounding environment will be directed along pathway 590 towards image sensor 570 in bridge 414, and light traveling along pathway 312 of virtual image pane 300 will be directed at the beam splitter towards the users eye.

### Formation and Assembly of Lens 200 and Virtual Image Pane 300

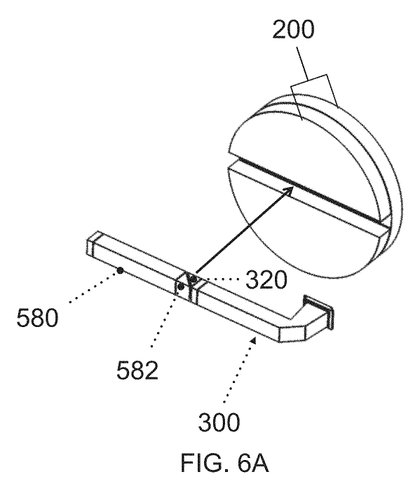

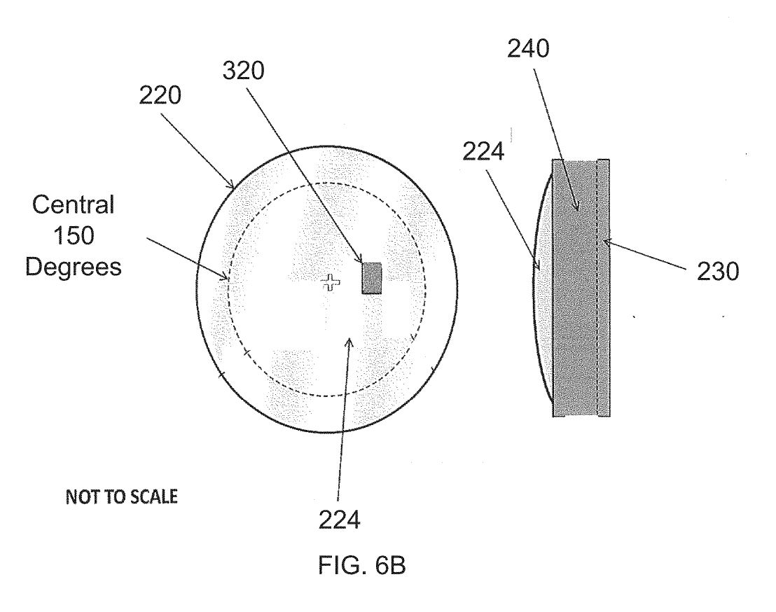

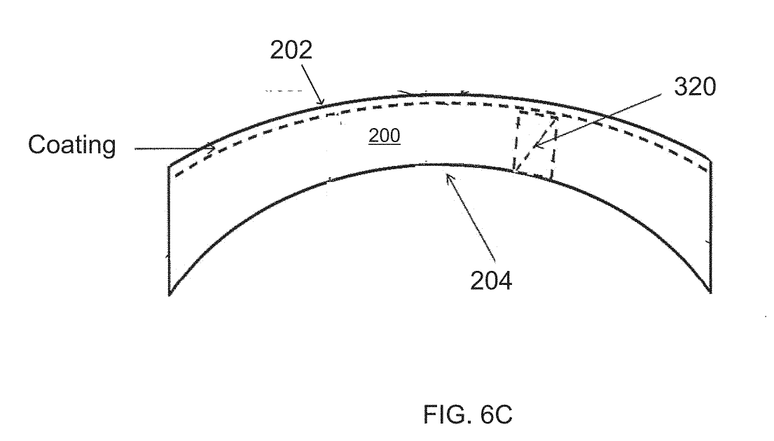

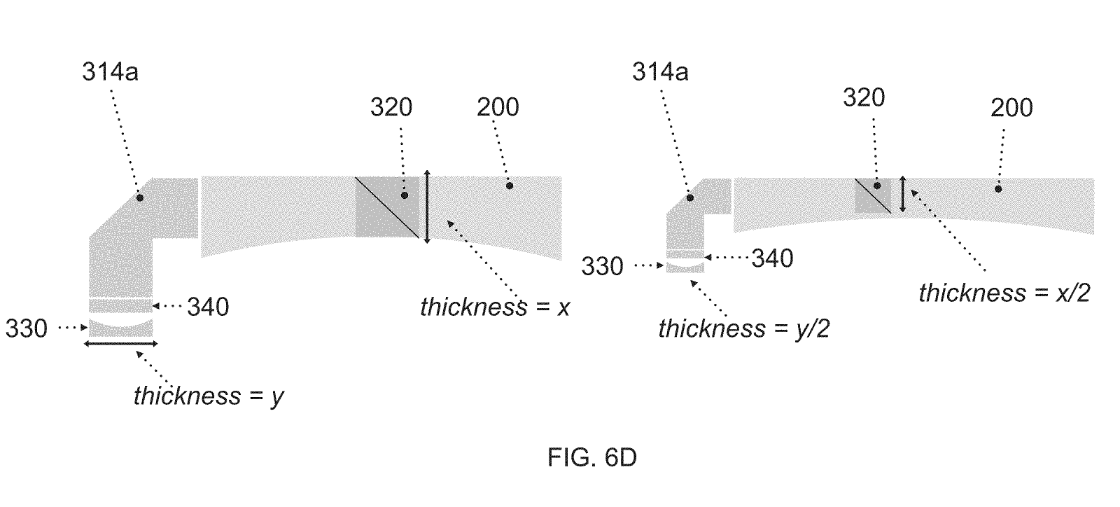

Virtual image pane 300, in an embodiment, may be formed separately and coupled with lens 200. For example, as previously noted and now depicted in FIG. 6A, virtual image pane 300 may be formed separately and positioned within recess 210 of lens 200.

An integral construction, on the other hand, may be more aesthetically pleasing, improve comfort by minimizing obscurations, refractions, or effects similar to those in a dispersive prism that occur due to any small gaps that may otherwise be present between the outer surfaces of a separately-formed virtual image pane 300 and the inner surfaces of recess 210. Accordingly, in another embodiment, all or portions of virtual image pane 300 may be formed as an integral part of lens 200. By way of example, those components of virtual image pane 300 to be included within lens 200 may be placed in a mold, where they may subsequently be overmolded to form ophthalmic lens 200 and that portion of virtual image pane 300 as one continuous component. In one such embodiment, only reflector 320 may be included in lens 200—lens 200 itself may serve as wave guide 314, and focusing lens 330 and collimator 340 may be placed near light source 310 in end piece 416. Of course, any suitable combination of the various embodiments of wave guide 314, focusing lens 330, and collimator 340 may be integrally included within lens 200 as well in other embodiments. Each of wave guide 314, focusing lens 330, collimator 340, and reflector 320 may be made of mostly transparent or semi-transparent materials so as to improve the aesthetics of lens 200 and minimize visual discomfort of a user.

Referring to FIG. 6B, an example manufacture of lens 200 having an integral reflector 320 is shown. A mold 220 having a front 220 and back 230 may be provided. Front mold 220 may have concave surface 222 for forming a front surface 202 of a lens blank suitable for subsequent shaping and finishing to form lens 200. Next, reflector 320 may be releasably coupled to the inside of concave front mold surface 222. Coupling may be achieved in any suitable way including, without limitation, through the use of an adhesive (possibly configured to release upon exposure to a predetermined amount of thermal energy or mechanical force), a slight amount of lens matrix resin, a transferable hard coat or anti-reflective coating, and/or a minute indentation in the inside of front mold surface 222. Then, back mold 230 may be situated opposite front mold 220 at a predetermined spacing, and subsequently secured thereto using tape, a gasket, or any other suitable coupling mechanism 240. Curable lens resin may then be introduced into the mold and cured according to any suitable process known in the art. The resulting blank may then be de-molded to yield a blank having an integral reflector 320 therein. In an embodiment, lens blanks may range between about 60 mm to 80 mm in diameter, and more commonly, between about 70 or 75 mm in diameter. Of course, lens blanks of any suitable dimensions may be formed and utilized in accordance with the teachings of the present disclosure.

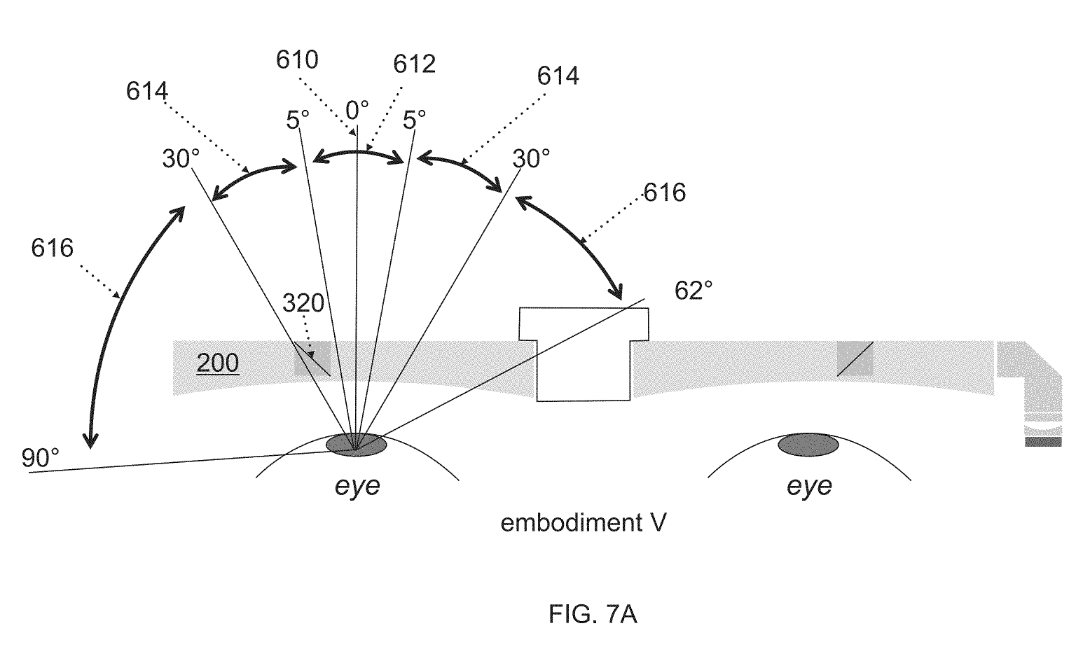

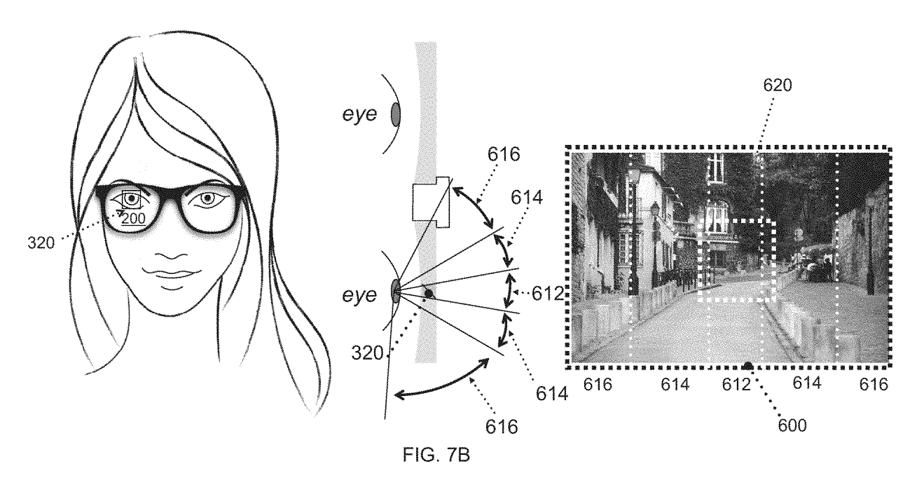

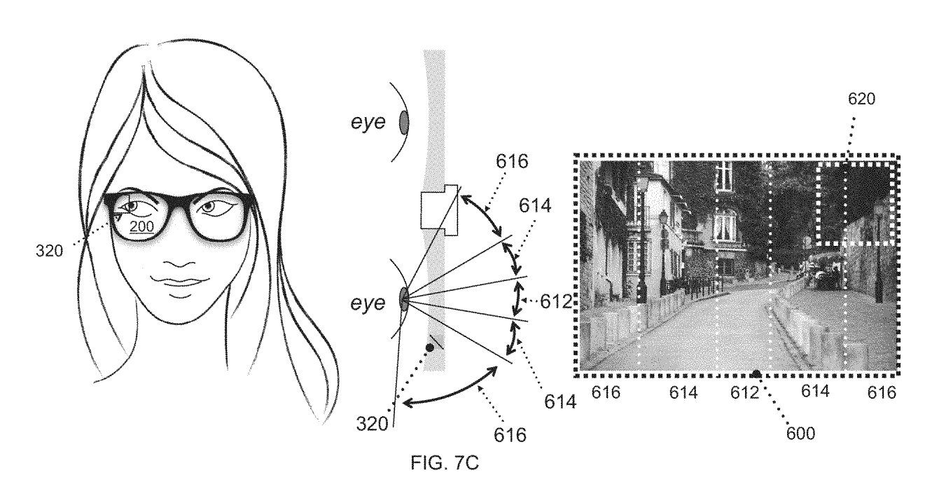

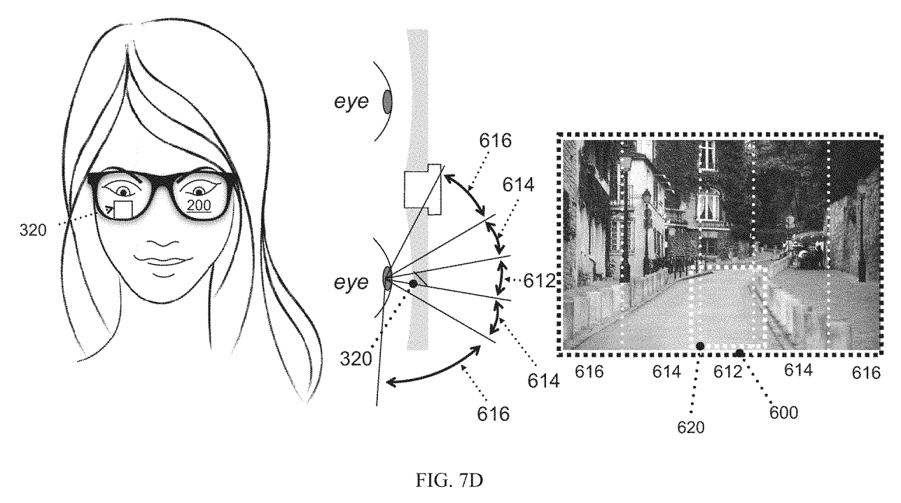

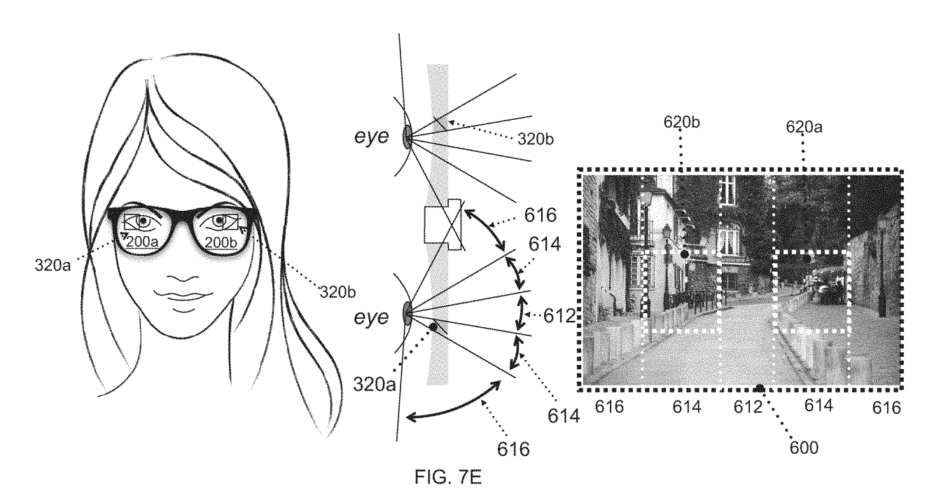

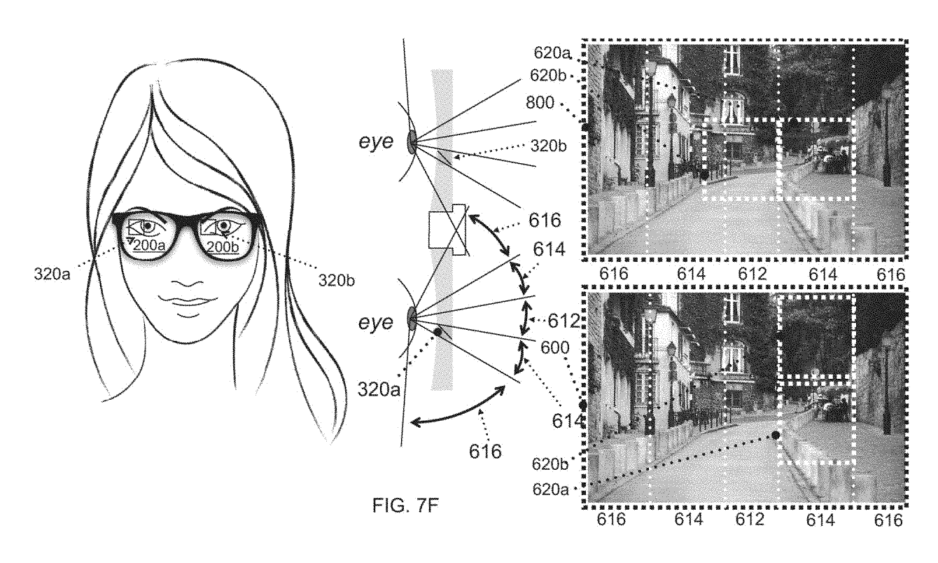

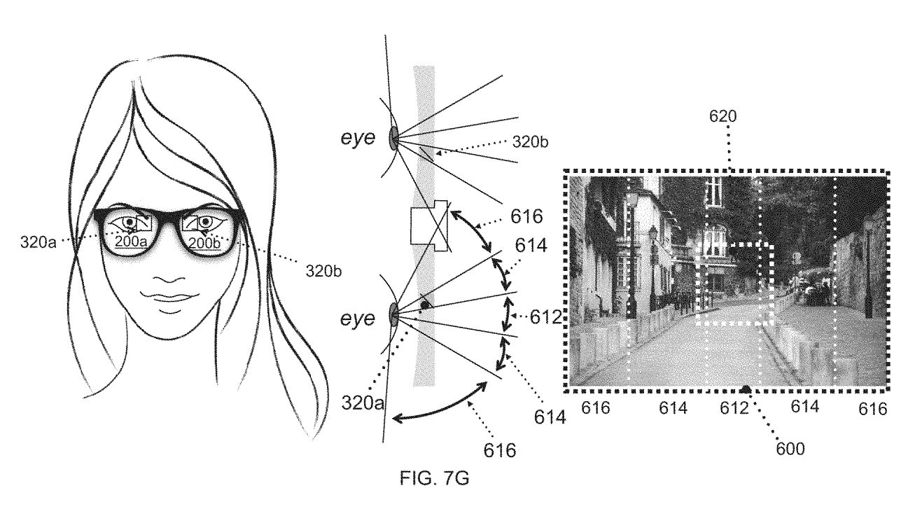

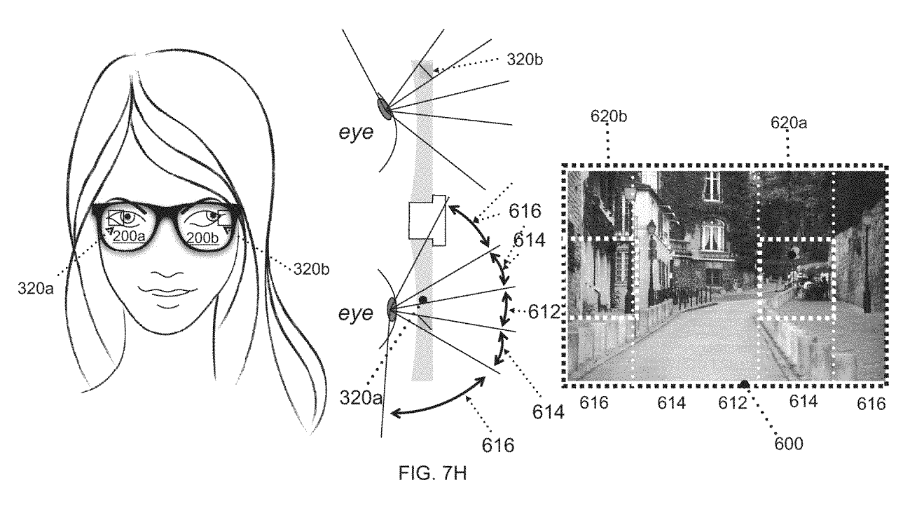

Reflector 320 (and any corresponding portions of virtual image pane 300 to be included) may be placed in any suitable location in the lens blank (and by extension, lens 200). In general, reflector 320 may be placed such that it is situated in a user's field of view. In an embodiment, reflector 320 may be placed within about 75 degrees in any direction of a user's central line of sight, as shown. Specific placements, and their effects on the positioning of virtual image(s) in a user's field of view, are later described in more detail in the context of FIGS. 7B-7H.

Referring now to FIG. 6C, in various embodiments, reflector 320 may form a small portion of a front surface 202 of the lens blank, especially if reflector 320 was situated up against inner front mold surface 224 during manufacture. In such cases, it may be desirable to apply a protective coating to prevent damage any exposed portion of reflector 320. Any suitable coating 206 known in the art may be applied to the exposed portion of reflector 320 (and all or a portion of front lens surface 202, if desired), such as a cushion coat, hard scratch-resistant coat, anti-reflective coat, photochromatic coating, electrochromic coating, thermochromic coating and primer coating, amongst others. In other embodiments, reflector 320 may be completely embedded within the blank, obviating the need for a protective coating thereon. Such may be the case when reflector 320 is coupled to front mold inner surface 224 using slightly cured or uncured lens matrix resin or a transferable coating.

Of course, whether reflector 320 is exposed or not, protective and other coatings may be applied to lens 200 if desired. In fact, aside from their standard optical applications, a number of treatments may be used to enhance the quality of the virtual image as perceived by the wearer. In one embodiment, an active or passive light transmission changeable material may be coated onto front lens surface 202 to enhance visibility of the virtual image in bright ambient light by preventing washout of the image. Examples include, without limitation, a photochromic, electrochromic, or thermochromic coating configured to darken in bright light (active), or a mirrored or sun tinted coating (passive). In another embodiment, portions of beamsplitter 320 may be provided with differing refractive indexes to provide the reflection. In yet another embodiment, a high illumination display may be provided to enhance the virtual image as perceived by the user. In still another embodiment, a reflective metal oxide, such as aluminum oxide, may be provided as or to enhance reflector 320, to produce a more intense image. Still further, in an embodiment including multiple reflectors 320, these reflectors 320 may be tilted slightly away from one another to enhance the binocularity of the image quality. Moreover, the index of refraction of reflector 320 may, in some embodiments, be limited to within about 0.03 units of index of refraction or less to reduce reflections at night from stray light rays (whilst also enhancing the aesthetics of lens 200). Of course, one or more of these treatments may be combined in any given embodiment to enhance the quality of the virtual image.

Referring now to FIG. 6D, the thickness of virtual image pane 300—and, by extension, the thickness of lens 200—may be reduced by distributing the display of the virtual image amongst multiple virtual image panes 300. In this way, only portions of a given virtual image need be displayed by corresponding virtual image panes 300, allowing its corresponding reflector 320, in particular, to be smaller.

By way of example, FIG. 6D depicts portions of the following embodiments for comparison purposes: a) on the left, a spectacle-like embodiment in which one of two lenses 200 includes a virtual image pane 300; and b) on the right, a spectacle-like embodiment in which both lenses 200 include respective virtual image panes 300. In this example, both embodiments are configured to display the same virtual image(s) identically in a user's field of vision (i.e., same image, same size, etc). In embodiment (a), reflector 320 must have the capacity to display the entire virtual image on its own, and is thus larger in dimensions to accommodate the extra light bandwidth. On the other hand, in embodiment (b), there are two reflective surfaces 300 (one for each virtual image pane) in the spectacles—one in each lens 200—to share the light bandwidth, and thus each reflector 320 may be smaller in dimensions. For clarity, in embodiment (b), the reflective surface shown could, for example, display half of the virtual image, and the reflective surface not shown (in the right lens) could display the other half of the virtual image. In an embodiment, thickness dimensions of virtual image pane 300 could be reduced by about half by distributing the virtual image amongst two virtual image panes 300, as shown in FIG. 6D.

A thinner virtual image pane 300 may provide for a thinner lens 200. In such an embodiment (i.e., two lenses 200, each having a virtual image pane 300), a lens 200 configured for minus optical power or plano optical power may have a center lens thickness of about 3.5 mm or less. In some cases, the center thickness may be less than about 3.0 mm. These reductions in dimensions may provide for increased comfort and aesthetics. One having ordinary skill in the art will recognize that portions of frame 400 may also be correspondingly reduced in size; in particular, rims 412 (by virtue of thinner lenses 200) and end pieces 416 (by virtue of smaller light sources 310).

Regardless of whether virtual image pane 300 is coupled with or formed integrally with lens 200, the associated virtual image will originate from within the plane of an associated lens 200. Such an arrangement differs considerably from other display technologies in the arrangement of the present invention has the optical elements completely contained within the ophthalmic lens and or waveguide and not necessarily attached to a frame front, end piece, or temple. For example, the ReconJet system by Recon Intruments, has a display placed in front of a lens that allows the wearer to see the image of said display in focus. And for example the Google Glass product, which is similar the ReconJet System, but that also requires an additional lens placed behind the optical system.

### Merged Field of Vision 600

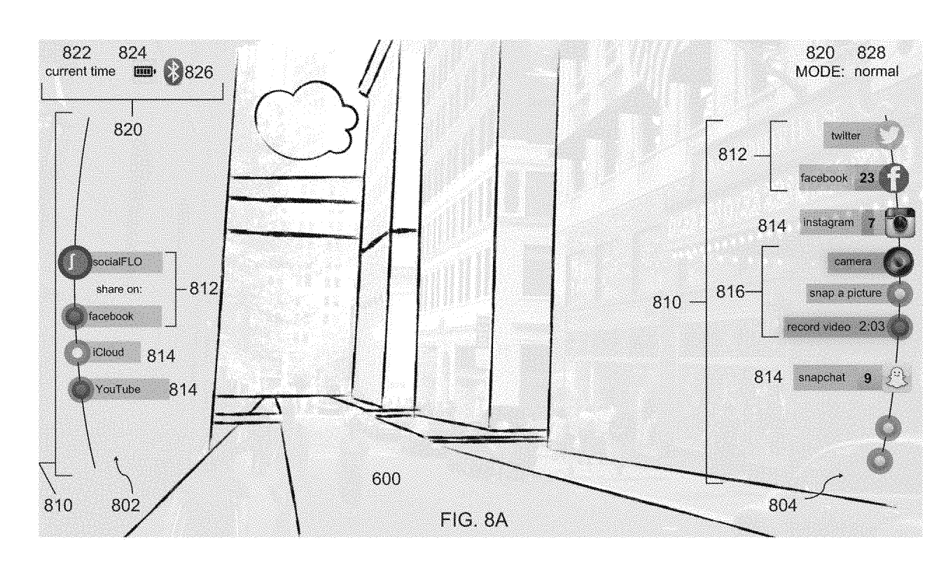

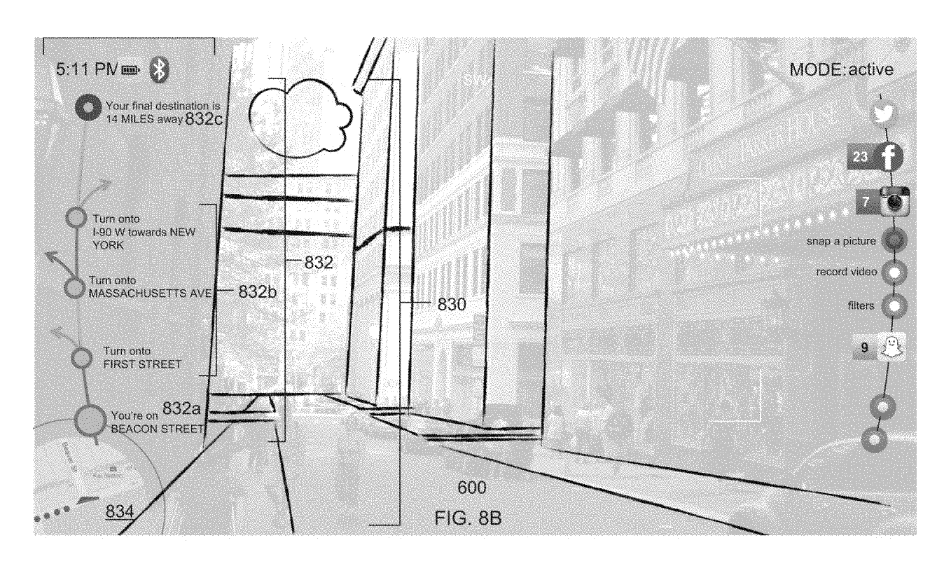

FIGS. 7A-8B illustrate representative configurations of a merged field of vision 600 and components thereof. It should be understood that the components of merged field of vision 600 shown in FIGS. 7A-8B are for illustrative purposes only, and that any other suitable components or subcomponents may be used in conjunction with or in lieu of the components comprising merged field of vision 600 described herein.

Merged field of vision 600 may be defined, in part, by the virtual image(s) 620 generated by augmented reality system 100 in various embodiments. As previously described, virtual image(s) 620 is focused at a distance (i.e., farther away than a user's glasses lenses), much like a user's focus would be during daily activities such as walking, driving a car, reading a book, cooking dinner, etc. As such, these common focal ranges allow virtual image(s) 620 to merge with a user's natural field of vision, forming a merged field of vision 600. Focal distance, in some embodiments, can be controlled after manufacture if system 100 is equipped with a tunable lens 330. Merged field of vision 600, in various embodiments, may include anything in the user's natural field of vision and virtual image(s) 620 generated by system 100, as described in further detail herein. Such an arrangement may provide for virtual image(s) 620 to appear overlaid on the user's natural field of vision, providing for enhanced usability and comfort, unlike other technologies that provide displays at a very short focal distance to the user.

### Exemplary Configurations

Referring now to FIGS. 7A-7H, virtual image(s) 620 may be displayed in merged field of vision 600 in any suitable size, shape, number, and arrangement. Virtual image(s) 620 may overlay a portion, various portions, or an entirety of the user's field of vision. In embodiments configured to display multiple virtual images 620, each may be separated, adjacent, or partially/fully overlapping. Some exemplary configurations are now provided herein.

Referring to FIG. 7A, a schematic of a user's field of vision is first provided to better explain various configurations in which virtual image(s) 620 may be displayed in a user's field of vision to form merged field of vision 600. It should be recognized that reference portions 610, 612, 614, and 616 of a user's field of vision defined therein are mere approximations, and are for reference purposes only, and that modifications may be made without departing from the scope and spirit of the present disclosure.

For reference, a user's central line of sight 610 may be defined as straight ahead, and is associated with 0° in FIG. 7A. Spanning about 5° in either direction of central line of sight 610 is a user's central field of vision 612. A user need not move its head or eyes substantially to view objects in central field of vision 612. Spanning about 30° in either direction from the boundaries central field of vision 612 is a user's near-peripheral field of vision 614. For clarity, near-peripheral field of vision is defined herein as spanning from about 5° to 30° in either direction of central line of sight 610. A user may need to move its eyes but not its head to view objects in near-peripheral field of vision 614. Lastly, peripheral field of vision 616 extends about another 60° beyond the boundaries of near-peripheral field of vision 614. Stated otherwise, peripheral field of vision extends between about 30° to 90° in either direction of central line of sight 610. A user would likely need to move its eyes and possibly head to clearly view an image in this region.

FIGS. 7B-7H depict various placements of reflector 320 in lens 200, alongside an associated merged field of view 600 provided thereby. In particular, portion (a) of each figure schematically depicts a possible placement (laterally and vertically) of reflector 320 in a lens 200. Portion (b) schematically depicts where such placement would fall laterally in a user's field of vision. Portion (c) schematically depict where a resulting virtual image 620 may be located in a corresponding merged field of vision 600. For reference, fields of vision 612, 614, and 616 have been depicted in portions (b) and (c).

It should be noted that, for simplicity, only reflector 320 of virtual image pane 300 is referred to in the context of these figures. Of course, other components of virtual image pane 300 are present, and are arranged in a suitable manner so as to direct light from light source 310 to reflector 320 in lens 200.

Referring to FIG. 7B, in an embodiment, reflector 320 may be placed in a central area of lens 200, as shown in portion (a), so as to be located in the user's central field of vision 610, as shown in portion (b). As shown in portion (c), the associated virtual image 620 may be placed directly in the center of the users field of vision. While this may be desired in some applications, virtual image 620 may obstruct central field of vision 610, possibly occluding a user from reading text, or from noticing objects in its path.

Referring to FIG. 7C, in another embodiment, reflector 320 may be placed in an upper corner area of lens 200, as shown in portion (a), so as to be located in the user's peripheral field of vision 616, as shown in portion (b). As shown in portion (c), the associated virtual image 620 may be placed in an outer and upper portion of the users field of vision, which may relieve the aforementioned occlusion issues, but require the user to look far outward to reference virtual image 620. Noticeable head and eye movement may be necessary, potentially decreasing user comfort.

Referring to FIG. 7D, in another embodiment, reflector 320 may be placed in an lower central area of lens 200, as shown in portion (a), so as to be located in the user's central field of vision 610, as shown in portion (b). As shown in portion (c), the associated virtual image 620 may be placed in an lower and central portion of the users field of vision. This may be a convenient location for an oft-referenced virtual image, whilst minimizing occlusion of mid and upper portions of central field of vision 612.

Referring to FIG. 7E, in another embodiment, two reflectors 320a,b may be placed in somewhat outer portions of two lenses 200a,b, respectively, as shown in portion (a), so as to be located in the user's near-peripheral field of vision 614, as shown in portion (b). Each may be configured to display virtual images 620a,b, respectively. As shown in portion (c), the associated virtual images 620a,b may be placed in opposing near-peripheral portions 614 of the users field of vision. This may be a convenient location for oft-referenced virtual images 620, whilst minimizing occlusion of central field of vision 612.

Referring to FIG. 7F, in another embodiment, a reflector 320a may be placed in a somewhat outer portion of lens 200a, and another reflector 320b may be placed in a somewhat inner portion of lens 200b, as shown in portion (a). Each may be located on the same side of the user's near-peripheral field of vision 614, as shown in portion (b). Such an embodiment may be used in connection with computer vision enhancement. Any optical system that involves and image sensor and a computer to identify objects is computer vision.

Referring to FIG. 7G, in another embodiment, two reflectors 320a,b may be placed in somewhat inner portions of two lenses 200a,b, respectively, as shown in portion (a), so as to be located in the user's near-peripheral field of vision 614, as shown in portion (b). As shown in portion (c), the resulting virtual images 620a,b may appear as a 3-D image in the central portion 612 of the users field of vision. This is commonly known to anyone who familiar with the art of creating 3D images from two images.

Referring to FIG. 7H, in another embodiment, reflectors 320a,b may be placed in slightly different locations on lenses 200a,b, as shown in portion (a). This can be done to account for a divergent field of view in one or both of the eyes, as may be the case in persons suffering from amblyopia, or “lazy eye.” For example, in the case of a “lazy” left eye, corresponding reflector 320b may be placed further outward on lens 200b to achieve proper positioning in a desired portion of the user's field of view. As shown in portions (b) and (c), such placement on lens 200b provides for reflector 320b to be positioned within near-periphery field of vision 614 like reflector 320a, so as to place virtual images 620a,b in near-peripheral portions 614a,b of the user's field of view.

As noted above, these examples represent only a few of the many possible configurations augmented reality system 100 and associated merged field of vision 600, and that one of ordinary skill in the art will recognize, in light of the present disclosure, any number of additional combinations.

### Exemplary Content

As shown in FIGS. 8A and 8B, merged field of vision 600 may include two sidebars 802, 804 defined by two corresponding virtual image 620a,b. In an embodiment, virtual images 620a,b (and sidebars 802, 804 presented thereby, respectively) may be provided by two virtual image panes 300a,b, respectively. For example, first and second virtual image panes 300a,b situated on the left and right sides of system 100 may display first and second virtual images 620a,b as sidebars 802 and 804, respectively. In the particular embodiments of FIGS. 8A and 8B, the content displayed in virtual images 620 is different from one another; however, it should be noted that virtual images 620a,b may present identical images containing identical information. Of course, these are just illustrative embodiments, and any number of display configurations are envisioned. It should be further recognized that virtual image(s) need not be positioned only in the periphery of merged field of vision 600, and that one skilled in the art will recognize suitable configurations based on the information to be merged with a user's natural field of vision in a given application.

As shown in FIGS. 8A and 8B, in various embodiments, a variety of information may be presented in virtual image(s) 620 of merged field of vision 600. In an embodiment, one or more widgets 810 may be presented in virtual images 620 as part of merged field of view 600. Widgets 810 may include representations of various propriety and third party software applications, such as social media apps 812 (e.g., SocialFlo, Facebook, Twitter, etc.) and image processing and sharing apps 814 (e.g., Instagram, Snapchat, YouTube, iCloud). Widgets 810 may further include representations of software applications for controlling aspects of system 100's hardware, such as imaging apps 816 (e.g., camera settings, snap a picture with imaging sensor 570, record video with imaging sensor 570, etc.). Of course, widgets 810 may be representative of any suitable software application to be run on system 100.

In various embodiments, widgets 810 may provide full and/or watered-down versions of its respective software application, depending on memory, processing, power, and human factors considerations, amongst others. Stated otherwise, only select functionality and information may be presented via a given widget 810, instead of the full capabilities and data content of a full version of an app that may otherwise be run on a home computer, for example, to save memory, improve processing speeds, reduce power consumption, and/or to avoid overloading a user with too much or irrelevant information, especially considering that the user may be engaged in distracting activities (e.g., walking, driving, cooking, etc.) whilst operating system 100.

Widget 810, in some embodiments, may provide relevant information concerning its corresponding software application. For example, as shown, some widgets 810 may provide an indicator of social media notifications (see, e.g., 23, 7, and 9 new notifications on Facebook, Instagram, and Snapchat, respectively, in side bar 804). As another example, imaging widgets 816 may display the length of a recording video (see, e.g., the indicator that a video has been recording/was recorded for 2 minutes and 3 seconds in side bar 804). Additionally or alternatively, indicators may be provided to indicate that a particular action for a given widget 810 may be selected. For example, an action indicator may include an illuminated, underlined, or animated portion of widget 810, or a change in the color or transparency of widget 810.

Widgets 810 may be presented in any suitable arrangement within virtual image(s) 620 of merged field of view 600. In an embodiment, widgets 810 may be docked in predetermined locations, such as in one or more of side bars 802, 804, as shown. Here, widgets 810 are shown docked along a common slightly-curved line, though any spatial association and organization, such as a tree structure, may be utilized.

Operating information 820 may also be presented in virtual image(s) 620 of merged field of vision 600. For example, referring to the upper corners of FIGS. 8A and 8B, operating information such as the current time 822, battery life 824, type and status of a communications connection 826, and a given operating mode 828 may be presented along with or in lieu of widgets 810. It should be recognized that these are but mere examples of operating information 820 that may be provided, and arrangements in which it may be provided, and that any number of suitable combinations of operating information 820 may be provided in merged field of vision 600.

Referring now to FIG. 8B, in another embodiment, navigational information 830 may be presented in virtual image(s) 620 of merged field of vision 600. In an embodiment, turn-by-turn directions 832 may be provided, including current street information 832a, upcoming street information 832b, and final destination information 832c. This information may be conveyed in any suitable form known in the art including, without limitation, characters, text, icons and arrows. Traffic information may be further provided. In another embodiment, a map 834 may additionally or alternatively by provided. Both may update based on the user's location. For example, turn-by-turn directions 832 may cycle from one step to another as the user approaches its destination and/or recalculate its route should the user take a wrong turn. Similarly, map 834 may pan, rotate, zoom in/out, or the like based on the users progress. As presented in merged field of view 600, a user may more easily and safely navigate to a destination than with other technologies that may require a user to look away from the road, or shift its focus between near and far away focal points.

It should be recognized that the appearance of virtual image(s) 620 in merged field of vision 600, and/or the content displayed, may be changed during operation of system 100 in other ways as well. In particular, virtual image(s) 620 may be removed; reduced or enlarged in size; rearranged; modified in shape, color, transparency, or other aspects; altered in content; altered in the rate at which content is displayed; or otherwise modified for any number of reasons, as later described.

In an embodiment, a user may input a control command to effect such change, such as a voice command to microphone 520, a physical command to buttons 530, or a command transmitted to transceiver 550 from an electronic device to which system 100 is in communication (e.g., user may tap a command on its mobile phone). In another embodiment, changes in appearance and content may be automatically controlled based on inputs received from various electronic components.

In various embodiments, the content and appearance of the virtual image(s) 620 may be further defined by an operating mode 828 of system 100. That is, certain sets of predetermined parameters may be associated and imposed in a given operating mode 828, such as “normal” mode, “active” mode, “fitness” mode, “sightseeing” mode, etc. In an embodiment, mode 828 may be selected or otherwise initiated by user input. For example, a user may use buttons 530 to toggle to a desired mode, such as “sightseeing mode,” when the user is interested in knowing the identity and information concerning certain landmarks in merged field of view 600. In another example, a particular mode, such as “active” mode, may be initiated in connection with a user's request for navigational directions.

In other embodiments, a particular mode 828 may be automatically initiated based on sensory or other inputs from, for example, electronic components 500 of system 100 or an electronic device in communication with system 100. Any number of considerations may be taken into account in determining such parameters including, without limitation, whether the user is stationary or mobile, how fast the user is moving, weather conditions, lighting conditions, and geographic location, amongst others.

Following are illustrative embodiments of various modes 828, and possible associated changes in content and appearance of the virtual image(s) in merged field of vision 600:
Normal Mode—May be similar to that shown in FIG. 8A.
Browsing Mode—Maximum content and spatial coverage. The user wishes to browse content such as social media updates, YouTube videos, etc. The user may be stationary, in some cases, such that distractions are less of an issue.
Active Mode—Consistent with walking, running, driving, etc. Aspects of the virtual image(s) and content displayed therein may be adjusted based on geospatial information, such as a position, velocity, and/or acceleration of the user, detected and/or measured. For example, the size of the virtual image(s) may be reduced to decrease that portion of the user's natural field of vision that may be obstructed by the virtual image(s). Further, the amount and type of information presented in the virtual image(s) may be reduced or changed to minimize distraction. For example, as shown in FIG. 8B, some or all social media widgets 812 may be removed to reduce distractions, and turn-by-turn directions 832 and/or map 834 may appear. The amount of upcoming street information 832b, for example, may be reduced to avoid providing too much information to the user, or increased to help the user avoid missing a turn, depending on user preferences, navigational complexity, and a rate at which the user is moving, amongst other factors. Similarly, the rate at which said content is displayed may be correspondingly adjusted based on the geospatial information.
Fitness Mode—May display information from another electronic device or fitness monitor such as a Nike fuel band or Jawbone up.
Sightseeing Mode—The virtual image is displayed to overlay a particular object or location of interest in the user's natural field of view. May work in concert with imaging sensor 570 to do so. Provides the identity and relevant historical information concerning the object or location.

It should be recognized that these are merely illustrative examples, and one of ordinary skill in the art will recognize appropriate appearances of the virtual image(s) 620 in merged field of view 600 for a given application.

While the present invention has been described with reference to certain embodiments thereof, it should be understood by those skilled in the art that various changes may be made and equivalents may be substituted without departing from the true spirit and scope of the invention. In addition, many modifications may be made to adapt to a particular situation, indication, material and composition of matter, process step or steps, without departing from the spirit and scope of the present invention. All such modifications are intended to be within the scope of the claims appended hereto.

1. A system for displaying a virtual image in a field of vision of a user, the system comprising:
a lens for placement in front of an eye of a user;
a source for emitting a light beam associated with an image towards the lens; and
a reflector positioned at least partially within the lens, the reflector configured to manipulate the light beam to be focused at a location beyond the reflector, and to direct, from within the lens and towards an eye of the user, the manipulated light beam to display the image as a virtual image in the field of vision of the user.

2. (canceled)

3. (canceled)

4. (canceled)

5. (canceled)

6. A system as set forth in claim 1, wherein a surface of the lens includes a light transmission changeable material for enhancing visibility of the virtual image in bright ambient light.

7. A system as set forth in claim 1, wherein the light beam is directed along a pathway extending from the source, into the lens, along a body portion of the lens to the reflector, and towards the eye of the user.

8. (canceled)

9. (canceled)

10. (canceled)

11. (canceled)

12. (canceled)

13. (canceled)

14. A system as set forth in claim 1, wherein the reflector includes one of a reflective surface, a prism, a beam splitter, and an array of small reflective surfaces similar to that of a digital micrometer device.

15. A system as set forth in claim 1, wherein the reflector includes a reflective surface of a recess within the lens.

16. (canceled)

17. (canceled)

18. (canceled)

19. (canceled)

20. A system as set forth in claim 1, wherein the reflector is positioned in the lens so as to be located within about 75 degrees of a central line of sight of the user.

21. (canceled)

22. (canceled)

23. (canceled)

24. A system as set forth in claim 1, further including a focusing lens, situated along the pathway between the source and the reflector, for focusing the light beam.

25. (canceled)

26. (canceled)

27. (canceled)

28. A system as set forth in claim 1, further including at least one of a touch sensor, a microphone, an image sensor, and a microelectromechanical sensor.

29. A system as set forth in claim 1, further including a second reflector positioned at least partially within the lens, and configured to direct light from the surrounding environment along a second pathway extending through a second portion of the lens.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A method for displaying a virtual image in a field of vision of a user, the method comprising:
providing a lens having a reflector embedded at least partially therein;
placing the lens in front of an eye of the user;
projecting, onto the reflector, a light beam associated with an image;
manipulating, via the reflector, the light beam such that it is focused at a location beyond the reflector; and
directing, via the reflector, the manipulated light beam towards the eye of the user to display the image as a virtual image in the field of vision of the user.

42. (canceled)

43. (canceled)

44. (canceled)

45. (canceled)

46. (canceled)

47. (canceled)

48. (canceled)

49. A method as set forth in claim 41, wherein the reflector includes a reflective surface of a lens wave guide situated within the lens.

50. (canceled)

51. (canceled)

52. (canceled)

53. (canceled)

54. A method as set forth in claim 41, wherein, in the step of placing, the lens is placed such that the reflector is positioned in one of a central, near-peripheral, or peripheral portion of the field of vision.

55. (canceled)

56. A method as set forth in claim 41, wherein the step of projecting includes the sub-step of focusing the light beam before the light beam reaches the reflector.

57. (canceled)

58. A method as set forth in claim 41, wherein, in the step of projecting, the light beam is directed along a pathway extending from the source, into the lens, along a body portion of the lens, and to the reflector.

59. (canceled)

60. (canceled)

61. (canceled)

62. (canceled)

63. (canceled)

64. (canceled)

65. A method as set forth in claim 41, wherein, in the step of providing, the lens is provided with a second reflector embedded at least partially therein, the first and second reflectors being positioned so as to be associated with a first and second eye of the user, respectively.

66. (canceled)

67. (canceled)

68. (canceled)

69. (canceled)

70. A method as set forth in claim 41, wherein, in the step of providing, a second lens is provided, the second lens having a second reflector embedded at least partially therein.

71. (canceled)

72. (canceled)

73. (canceled)

74. (canceled)

75. (canceled)

76. A system for displaying a virtual image in a field of vision of a user, the system comprising:
first and second lenses for placement in front of first and second eyes of the user;
first and second reflectors positioned at least partially within the first and second lenses, respectively;
first and second sources for emitting first and second light beams associated with first and second images;
first and second pathways along which the light beams are directed, each pathway extending from the corresponding source, into the corresponding lens, along a body portion of the corresponding lens, and to the corresponding reflector; and
wherein the reflectors are configured to manipulate the corresponding light beams to be focused at locations beyond the reflectors, and to direct, from within the corresponding lens and towards the corresponding eye of the user, the corresponding manipulated light beams to display the associated images as virtual images separately in the field of vision of the user.

77. (canceled)

78. (canceled)

79. (canceled)

80. (canceled)

81. A system as set forth in claim 76, further comprising a wearable frame for housing the lenses, reflectors, and sources.

82. (canceled)

83. (canceled)

84. A system as set forth in claim 81, further including at least one image sensor and at least one collector situated in one of the lenses and in optical communication with the image sensor.

85. A system as set forth in claim 76, further including a transceiver for communicating with an electronic device.

86. A method for adjusting the display of content in a field of vision of the user based on movement of the user, the method comprising:
measuring at least one of a position, a velocity, or an acceleration of the user;
associating the measured position, velocity, acceleration of the user, or combination thereof, with the content to be displayed to the user; and
adjusting one of or a combination of the following for display to the user, based on the associated position, velocity, and/or acceleration of the user: an amount of the content to be displayed; a rate at which the content is to be displayed, and a size of the content to be displayed.
